(19) United States
(12) Patent Application Publication
(10) Pub. No.: US 2011/0196746 A1
(43) Pub. Date: Aug. 11, 2011

(54) SEARCH AUCTION INSIGHTS FOR ADVERTISERS

(75) Inventors: ZHAOHUI TANG, Bellevue, WA (US); DARRYN OWEN LAVERY, Seattle, WA (US); RONG JIAN GUAN, Sammamish, WA (US); TARUN KUMAR JAIN, Kirkland, WA (US); MICHAEL WALDMAN RECKHOW, Seattle, WA (US); TAO WANG, Redmond, WA (US)

(73) Assignee: MICROSOFT CORPORATION, REDMOND, WA (US)

(21) Appl. No.: 12/702,654

(22) Filed: Feb. 9, 2010

(51) Int. Cl. G06Q 30/00

(52) U.S. Cl. 705/14.71

(57) ABSTRACT

Systems, methods, and computer storage media having computer-executable instructions embodied thereon that provide insight to advertisers that participated in online advertiser auctions. A system receives data from one or more advertiser auctions and stores the data in a log. The log is queried for a sample of the data from the advertiser auctions. Data is extracted from the sample regarding advertisements submitted by the advertisers that participated in the advertiser auctions. Based on the data extracted from the sample, a report is generated that summarizes statistics and feedback regarding the advertisements that participated in the advertiser auctions. The report is displayed to a user. In embodiments, the report is automatically generated and displayed to the advertisers that participated in the advertiser auctions.

### BACKGROUND

Advertisements are commonly displayed in association with web content, such as a set of search results or a webpage. Selecting an online advertisement for display in association with the web content is generally based on a user search query available at the time of advertisement delivery.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention relate to systems, methods, and computer-readable media for, among other things, providing insight to advertisers regarding the outcome of advertiser auctions. Advertisers are provided with statistics and feedback relating to auction performance for their advertising campaigns.

### BRIEF DESCRIPTION OF THE DRAWINGS

The present invention is described in detail below with reference to the attached figures, wherein:

FIG. 1 is an exemplary computing environment suitable for use in implementing embodiments of the present invention;

FIG. 2 is a flow diagram showing a method for providing insight to advertisers based on advertiser auction performance.

FIGS. 3-5 are exemplary reports for use in implementing embodiments of the present invention;

FIGS. 6-7 are exemplary reports for use in implementing embodiments of the present invention; and

FIG. 8 is an exemplary system in which embodiments may be employed for providing insight to advertisers based on advertiser auction performance.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention relate to providing insight to advertisers regarding the outcome of advertiser auctions. An advertiser auction refers to a paid auction in which one or more advertisers compete to have one or more advertisements selected for display in association with web content. Such web content may be items of digital content presented on a webpage that is associated with a particular keyword or keywords. Alternatively, web content may refer to a search results webpage provided in response to a query for a particular keyword. An advertiser auction may be conducted in relation to one or more particular keywords. Accordingly, an advertiser may bid on one or more keywords in order to have an advertisement, or group of advertisements, selected for presentation in association with that particular keyword or keywords. As used herein, a keyword may include a single word or more than one word in the keyword term.

An auction in which advertisers submit advertisements for online display in association with a query for a particular keyword on a search results webpage may be referred to as a “search auction.” Search engines and search results webpage providers generate revenue through online advertisements positioned adjacent to a user's search query results. For example, many search engine providers, such as Microsoft, Google and Yahoo, receive payment from advertisers based upon pay-per-performance models, e.g. cost-per-click and cost-per-action\conversion models. Online auctions conducted by such providers are used to determine which advertisements will generate the most revenue when positioned next to search results. By way of example only, and not limitation, an online search auction may be conducted for the keyword “car.” As part of the search auction, an advertiser may submit bids or offers for the amount the advertiser is willing to pay to have its advertisement displayed in response to a search query that includes the keyword “car.”

A paid search auction refers to a search auction that an advertiser pays to participate in. As used herein, an advertiser auction may include one instance of a paid search auction, or multiple instances of paid search auctions. An advertiser that participates in an advertiser auction is referred to as a “participating” advertiser. As such, not all advertisers that seek to compete in an advertiser auction are selected for the auction, and therefore do not “participate” in the auction. In embodiments, participating advertisers submit one or more advertisements to an advertiser auction. Advertisers may submit groups of advertisements, referred to as an advertising group, or a group of participating advertisements. As a participating advertiser, an advertiser may bid on one or more keywords. By bidding on a keyword, the participating advertiser seeks to have its advertisement selected for presentation in association with items of digital content related to the keyword.

The outcome of an advertiser auction refers to the result of one instance or multiple instances of advertiser auctions. The outcome of an advertiser auction may relate to the advertisers that participated in the auction, or may relate to the advertisements that were submitted by advertisers that participated in the advertiser auction. In embodiments, the outcome of an advertiser auction results in an advertisement either being selected from or filtered out of the auction. For example, the outcome of a search auction may be that an advertiser's bid for a keyword in the auction was accepted. An advertisement that is selected as a result of an advertiser auction is referred to as creating an “impression.” An impression may result in the advertisement being presented in response to a search query for the keyword in the auction. Alternatively, the outcome of a search auction may be that an advertisement is filtered out of the auction, and therefore did not create an impression. Filtering an advertisement out of an auction refers to removing an advertisement from one or more advertisements submitted by advertisers participating in an auction.

In embodiments, a log is created from the results of advertiser auctions that have been compiled. The log is stored in a data store which can be accessed for data retrieval. The log may also be updated with the results of additional advertiser auctions. In embodiments, the log is updated periodically or continuously with data from additional auctions. As used herein, data refers to the results of advertiser auctions stored in the log. Such data may include items of information regarding one or more advertiser auctions. In embodiments, data relating to an advertiser auction may include the identity of the advertiser auction, the number and identity of the advertisers that participated in the advertiser auction, the advertisements that were submitted by the advertisers participating in the auction, the keywords that the advertisers were betting on in the auction, how the advertisement was filtered out of the auction, and the outcome of the auction itself. As previously discussed, the outcome of the advertiser auction may include whether an advertisement resulted in an “impression,” or whether the advertisement was filtered out of the auction. Additionally, making an impression in an advertiser auction may be referred to as “winning” an auction, while being filtered out of an auction may be referred to as “losing” an auction.

A sample of data is taken from the log of data. In embodiments, a script is run against the data from the log which extracts a sample from the log. For example, a sample may be taken from about 10% of the data stored in the log. An algorithm is applied to extract data from the sample which satisfies factors that indicate the reasons for the outcome of an auction. The algorithm may also aggregate such data for presentation to an advertiser, who may then determine why, after participating in an auction, the advertiser either won or lost the auction. Extracted data may provide insight that affects the way an advertiser chooses to advertise in the future, such as, for instance, by influencing whether the advertiser will continue to utilize the same or similar advertisements as those which were selected for a previous auction, etc. In embodiments, a query is run to extract a sample of data that relates to a single advertiser. For example, sample data may relate to a single advertiser, and the algorithm applied to the sample data may extract information that is specific to a single advertiser.

Samples of data may be extracted from the log at regular intervals. In embodiments, such regular intervals have configurable parameters which may be used to adjust the number of days between sampling. By way of example only, and not limitation, a parameter may be set which extracts a sample of the log every seven days. A parameter for the number of days between sampling may be adjusted during different times of the year to reflect the changing needs of different advertising markets. For example, samples may be extracted more often during the holiday season, when a dynamic marketplace influences more frequent changes in advertiser auctions.

Based on the data extracted from the sample, statistics and feedback are generated for the advertisements that participated in the advertiser auction. As such, the data extracted from the sample that satisfies particular factors indicates one or more particular reasons for advertiser auction outcomes. The reasons for filtration from an advertiser auction may relate to a particular advertising account, a particular keyword, a particular group of advertisements, and a particular advertising campaign. The factors which indicate one or more reasons for auction outcomes may be used to provide advertisement-level feedback or keyword-level feedback to an advertiser. For example, advertisement-level feedback may relate to such factors as advertisement copy quality, advertisement landing page relevance, and bidding price. Keyword-level feedback may relate to such factors as trademark conflicts and keyword relevance. In embodiments, results relevant to such factors are compiled and reported to advertisers.

As used herein, advertisement copy quality refers to the quality of a particular advertisement or group of advertisements. The quality of advertisement copy may affect whether an advertisement is successful in creating an impression, and therefore “winning” an advertiser auction. Alternatively, poor advertisement copy quality may reveal that an advertisement's copy was not good enough to prevent filtration of the advertisement. In embodiments, data extracted from a sample of advertiser auctions may reveal that a particular advertisement or group of advertisements presented poor copy quality which resulted in its filtration from the auction and subsequent “loss” of the auction. For example, an advertisement with poor copy quality is not likely to be clicked on by a user as often as other advertisements. Such low frequency of clicks may be extracted from the sample data and associated with the resulting advertisement-level feedback that the copy quality was poor. In embodiments, a recommendation may be made to an advertiser whose data revealed that its advertisement possessed poor copy quality. For example, based on advertiser auction data which reveals that an advertisement possessed poor copy quality, a recommendation may be made for the addition of more relevant keywords to an advertisement's copy or to an advertisement's title. The addition of more relevant keywords to an advertisement may result in a successful impression in future advertiser auctions.

Advertisement landing page relevance refers to the relevance of the webpage that a user is directed to when a user clicks on an advertisement. In embodiments, poor landing page relevance is associated with an advertiser that participated in an advertiser auction because of a particular keyword, but is then filtered out because of the lack of relevance of the advertiser's landing page. For example, an advertiser may bid in an auction for the keyword “car insurance,” but the advertiser's website may pertain to selling camping gear. In this case, the camping gear advertiser's website will demonstrate low relevance to the query “car insurance,” and will be filtered out of the auction. In other embodiments, an advertiser's webpage may have limited relevance with respect to a keyword, and may still be filtered from an auction. For example, a car dealership may be bidding on a number of keywords that include the keyword “rental car.” The advertiser may be filtered out of an advertiser auction because the dealership does not offer rental cars. As a result, a recommendation may be made that the advertiser should either remove the keyword “rental car” from its list of keywords to bid on, or should direct users from the dealership's landing page to another website which does offer rental cars.

Advertisement-level feedback regarding bidding price relates to the amount which an advertiser is offering to pay to win an advertiser auction. In embodiments, when bidding on a particular keyword that will be presented to a user in response to a search results query, an advertiser determines how much it will bid to win the auction. Based on data extracted from a sample of the advertiser auction results log, bidding price information may be determined for a particular advertiser or for a particular advertisement. A filtered advertisement may have been submitted by an advertiser that bid below what other advertisers were bidding for the same keyword. For example, when other advertisers submitted bids of $10 for each click on an advertisement, and an advertiser that lost the auction submitted a bid of $1 per click, feedback regarding bidding price may be generated regarding the advertiser's low bidding price. As such, despite strong advertisement copy quality and strong landing page relevance, an advertisement may still be filtered from an auction due to low bidding price.

Keyword-level feedback, such as, for example, trademark conflicts and keyword relevance feedback, may also be generated as a result of data extracted from the log of advertiser auction results. Trademark conflicts refer to a conflict or mismatch between a keyword search query and an advertiser or advertisement. For example, when a search query for a trademarked keyword conflicts with an advertiser's product or services, a result may be generated which indicates that a trademark conflict caused the advertisement to be filtered from the auction. Keyword relevance refers to the probability that a user will select an advertisement from an advertiser auction. For example, keyword relevance is strong when there is a high probability that a user will select the advertisement. Alternatively, low keyword relevance may be exhibited when the probability an advertisement being selected in an auction for a particular keyword is very low. As a result of data extracted from advertiser auction logs, a result may be generated which indicates that low keyword relevance caused an advertisement to be filtered from the auction.

Data extracted from the sample may also be used to generate statistics regarding one or more advertisers that participated in the advertiser auctions. In embodiments, statistics generated include an auction filtration ratio and an auction impression ratio. An auction filtration ratio refers to the rate at which an advertisement or a group of advertisements are filtered out of an auction. For example, a low auction filtration ratio represents an advertisement that was more likely to create an impression in an advertiser auction. Alternatively, a high auction filtration ratio represents an advertisement that was more likely to be filtered out of an advertiser auction. An auction impression ratio refers to the

Based on statistics, and other data extracted from the advertiser auction log, low-performing but high-potential advertisements or groups of advertisements may be identified. A low-performing but high-potential advertisement refers to an advertisement that is low-performing because it has a high filtration ratio, but has high potential because it is often selected to participate in advertiser auctions. As such, data may be evaluated which reflects how often a particular advertisement or group of advertisements participates in an auction, and what the filtration ratio is for that particular advertisement or group.

In embodiments, statistics and feedback regarding the outcome of advertiser auctions are displayed to a user. A user may be a participating advertiser that is requesting such information and insight regarding the outcome of advertising auctions. The display of such insights to advertisers may be provided directly to advertisers that participated in advertiser auctions. In embodiments, statistics and feedback are communicated automatically to advertisers. The insights may relate to a particular advertisement, or group of advertisements, and may also provide information on the keywords associated with the auctions. Additionally, insights into the outcome of advertiser auctions may relate to a particular advertising account, a particular keyword, a particular group of advertisements, or a particular advertising campaign. Insights regarding the outcome of advertiser auctions may be summarized in a report that is provided to one or more participating advertisers. The report may include both statistics and feedback relevant to the advertisements that participated in the advertiser auctions.

In one embodiment, a report is generated for a single advertiser that participated in an online advertiser auction. As such, the data extracted from the sample of online auction data may relate only to advertisements submitted by a single advertiser. The report for the single advertiser may be communicated automatically to the advertiser, or to third party that generated the advertisement for the advertiser, such as, for example, an advertising agency. For example, a report may be generated for one or more participating advertisements submitted by a single advertiser, and provided to an advertising campaign manager. The advertising campaign manager may then provide the report to the advertiser.

In embodiments, insights regarding the outcome of advertiser auctions are refreshed daily in order to reflect corrections to advertisements that were made in response to statistics and feedback. Insights may also be refreshed regularly to reflect the dynamic marketplace in which advertisers are competing. For instance, changes in advertiser behavior may be most prominent during holidays, when advertisers are increasing their advertising campaigns and seeking to increase sales during heavier shopping times. As such, advertisers are more interested in the impact that their advertisements have on the changing market, and on whether corrections to advertisements, or advertising campaigns, have an affect on the outcome of such advertiser auctions.

Accordingly, in one aspect, an embodiment of the present invention is directed to one or more computer-readable media storing computer-useable instructions that, when used by one or more computing devices, causes the one or more computing devices to perform a method. The method includes receiving data from one or more advertiser auctions, wherein one or more advertisers participated in the one or more advertiser auctions. The method also includes storing the data from the one or more advertiser auctions in a log. The method further includes querying the log for a sample of data from the one or more advertiser auctions. The method still further includes extracting data from the sample regarding one or more advertisements submitted by the one or more advertisers that participated in the one or more advertiser auctions. The method also includes, based on the data extracted from the sample, generating at least one of statistics and feedback for the one or more advertisements that participated in the one or more advertiser auctions. The method still further includes displaying one or more of statistics and feedback to a user.

In another embodiment, an aspect of the invention is directed to a computer system executed by one or more computer processors. The system includes a log component for storing data from one or more advertiser auctions, wherein one or more advertisers participated in the one or more advertiser auctions. The system also includes an extraction component for receiving, from the log component, a sample of data from one or more advertiser auctions, extracting data from the sample regarding one or more advertisements submitted by the one or more advertisers that participated in the one or more advertiser auctions, and generating one or more of statistics and feedback regarding the extracted data. The system further includes a reporting component for generating a report regarding the one or more advertisers that participated in the one or more advertiser auctions.

A further embodiment of the present invention is directed to one or more computer-readable media storing computer-useable instructions that, when used by one or more computing devices, causes the one or more computing devices to perform a method. The method includes receiving data from one or more advertiser auctions, wherein one or more advertisers participated in the one or more advertiser auctions. The method also includes storing the data from the one or more advertiser auctions in a log. The method further includes querying the log for a sample of data from the one or more advertiser auctions. The method still further includes extracting data from the sample regarding one or more advertisements submitted by the one or more advertisers that participated in the one or more advertiser auctions. The method also includes, based on the data extracted from the sample, gathering information regarding the one or more advertisements that were submitted by the one or more advertisers that participated in the one or more advertiser auctions. The method further includes generating one or more reports regarding the one or more advertisements that were submitted by the one or more advertisers that participated in the one or more advertiser auctions, further wherein the one or more reports include information regarding one or more of an auction filtration ratio, an auction impression ratio, advertisement copy quality, landing page relevance, bidding price information, trademark conflict, and keyword relevance. The method still further includes communicating the one or more reports to the one or more advertisers that participated in the one or more advertiser auctions.

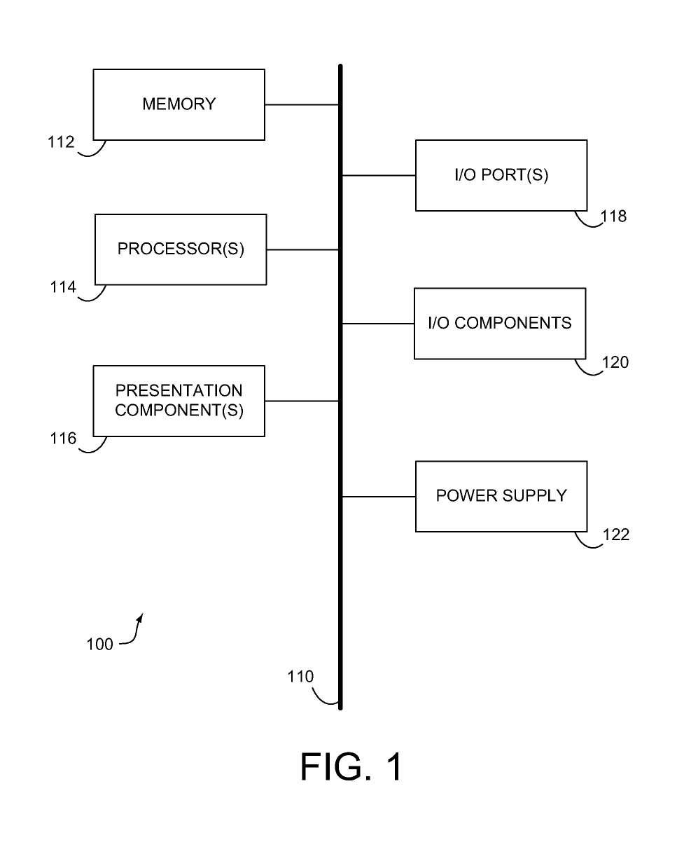

Having described an overview of the present invention, an exemplary operating environment in which various aspects of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, these blocks represent logical, not necessarily actual, components. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media implemented in any method or technology for storage of information such as computer-readable instructions, data structures, program modules or other data. Computer-readable media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Combinations of any of the above should also be included within the scope of computer-readable media.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

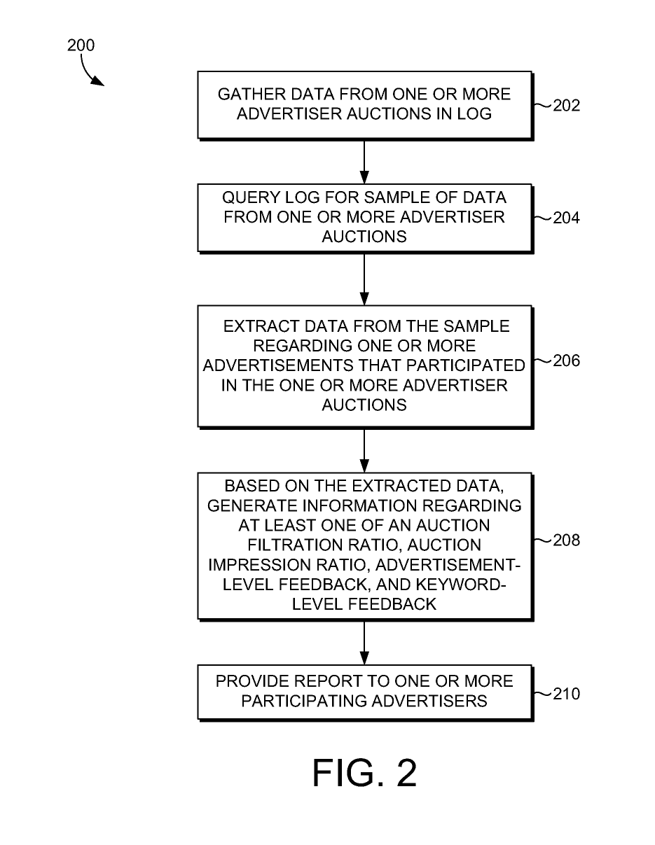

As indicated previously, embodiments of the present invention are directed to providing insight to advertisers regarding the outcome of advertiser auctions. Referring now to FIG. 2, a flow diagram illustrates a method 200 for providing insight to advertisers regarding the outcome of advertiser auctions in accordance with an embodiment of the present invention. Initially, as shown at block 202, data is gathered from one or more advertiser auctions. That is, data is collected or retrieved from one or more advertiser auctions and compiled in one or more locations. The location of the stored data may be referred to as a “log” of data. The log of data may be accessed for data retrieval, and updated as additional data is added to the log.

As shown at block 204, the log is queried for a sample of data from one or more advertiser auctions. In embodiments, a query may be conducted for a sample of data related to a single advertiser or multiple advertisers. In further embodiments, a query may be conducted for a sample of data related to a single or multiple advertisements. As such, a query may be conducted which relates to a particular advertising campaign, which may consist of a single or multiple advertisements submitted by a single or multiple advertisers. Samples of data may be retrieved from the log at varying intervals in time. For example, in embodiments, samples of data are retrieved at scheduled regular intervals. Alternatively, samples may be taken from the log when requested by a user.

At block 206, data is extracted from the sample regarding one or more advertisements submitted by the one or more advertisers that participated in the advertiser auctions. Data may be extracted by applying a single or multiple algorithms to the data. Data extraction may be manual or automatic, and may be conducted using the same or varying algorithms. Algorithms applied to the data to extract information may relate to a single or multiple aspects of the advertiser auctions. For example, data may be extracted which relates to the identity of the advertisers that participated in the advertiser auctions. Alternatively, data may be extracted which relates to the filtration of specific advertisements that were submitted by the advertisers that participated in the advertiser auctions.

As shown at block 208, information is generated from the extracted data which relates to at least one of an auction filtration ratio, an auction impression ratio, advertisement-level feedback, and keyword-level feedback. In embodiments, the data extracted from the sample may be specific to a particular user's request for information. In other embodiments, the data extracted from the sample may pertain to standardized or customized set of information generated by a particular provider. For example, a provider may generate a standard set of statistics and feedback for multiple advertisers that participated in advertiser auctions. This standard set of statistics and feedback may be generated by the provider upon request from an advertiser to whom the data pertains.

At block 210, a report is provided to one or more of the advertisers that participated in the advertiser auction. This report may be made available to the advertisers upon a request to a provider. In embodiments, the report may be generated automatically, upon sampling of data which takes place at regular intervals.

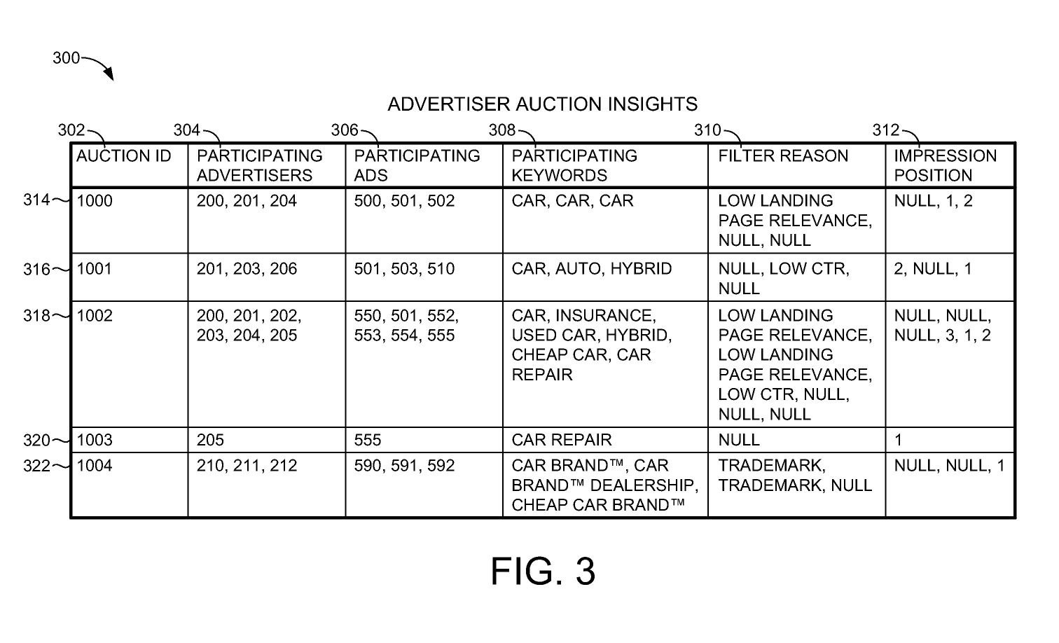

Information may be generated which provides insight to advertisers regarding the outcome of advertiser auctions. For illustrative purposes only, FIGS. 3-5 include exemplary reports for use in implementing embodiments of the present invention. It will be understood and appreciated by those of ordinary skill in the art that the exemplary displays of FIGS. 3-5 are provided by way of example only and are not intended to limit the scope of the present invention in any way.

With reference initially to FIG. 3, an exemplary report 300 is shown which may be presented to an advertiser to provide insight into advertiser auctions. Report 300 includes columns designating Auction ID 302, Participating Advertisers 304, Participating Advertisements 306, Participating Keywords 308, Filter Reason 310, and Impression Position 312. Auction ID 302 represents the identity of a particular auction used to determine which advertisements will be selected for display in association with a particular keyword search query. Participating Advertisers 304 represents the list of all advertisers that participated in the auction designated in Auction ID 302. Participating Advertisements 306 represent the advertisements that were submitted by the Participating Advertisers 304. Participating Keywords 308 represent the keywords that were participating in each advertiser auction. Filter Reason 310 represents the reasons why a particular Participating Advertisement 306 was filtered out of a particular advertising auction. For Participating Advertisements 306 that was not filtered out of an advertising auction, the value of the Filter Reason 310 is “NULL.” Impression Position 312 represents the list of advertisers that won the auction, and therefore resulted in an impression. For Participating Advertisements 306 that did not win the auction, the Impression Position 312 value is “NULL.” Individual instances of advertiser auctions are displayed in rows 314-322. For example, row 314 represents the results for auction 1000, with participating advertisers 200, 201, and 204. Participating advertisers 200, 201, and 204 submitted participating advertisements 500, 501, and 504 respectively. The participating keyword in auction 1000 was the keyword “car” for each of the advertiser participating advertisements. As such, advertisement 500, submitted by advertiser 200, was filtered out of auction 1000 because of “low landing page relevance,” as designated by the display in Filter Reason 310. Because advertisement 500 was filtered out of auction 1000, the impression position was “NULL” under Impression Position 312.

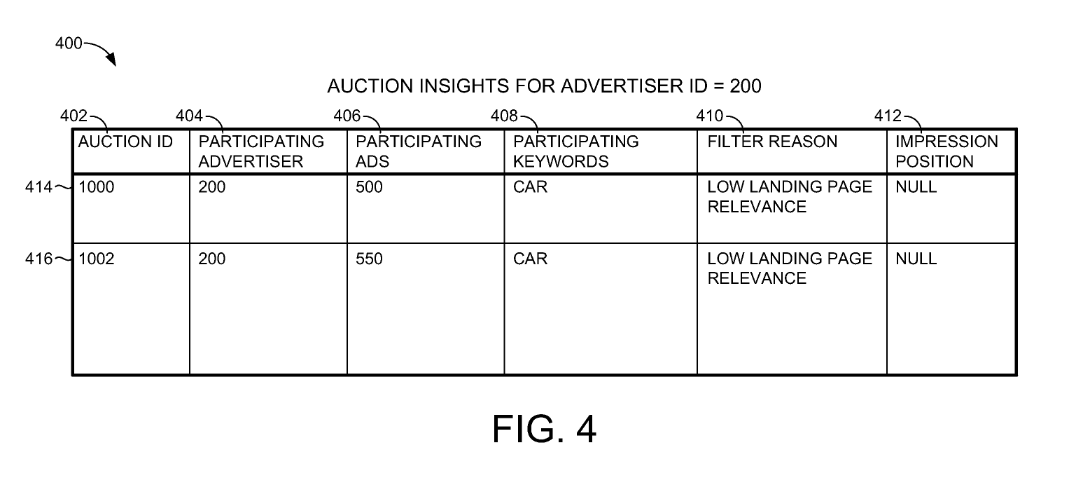

As shown in FIG. 4, an exemplary report 400 is shown which may be presented to provide insight to Advertiser ID 200. Report 400 includes columns designating Auction ID 402, Participating Advertiser 404, Participating Advertisements 406, Participating Keywords 408, Filter Reason 410, and Impression Position 412. Auction ID 102 represents the identity of a particular auction used to determine which advertisements will be selected for display in association with a particular keyword search query. Participating Advertiser 404 represents the advertiser that participated in the auction designated in Auction ID 402, and for whom the report is being generated. Participating Advertisements 406 represent the advertisements that were submitted by the advertiser in Participating Advertiser 404. Participating Keywords 408 represent the keywords that were participating in each advertiser auction. Filter Reason 410 represents the reasons why a particular Participating Advertisement 406 was filtered out of a particular advertising auction. For Participating Advertisement 406 that was not filtered out of an advertising auction, the value of the Filter Reason 410 is “NULL.” Impression Position 412 represents the value assigned to the advertisement that won the auction, and therefore resulted in an impression. For Participating Advertisements 406 that did not win the auction, the Impression Position 412 value is “NULL.” Individual instances of advertiser auctions are displayed in rows 414-416. For example, row 414 represents the results for auction number 1000 for participating advertiser number 200 that submitted participating advertisement number 500. In auction number 1000, for participating keyword “car,” the filter reason was “low landing page relevance.” The report also summarizes, at row 416, the results of auction number 1002 for participating advertiser number 200 that submitted participating advertisement 550. The participating keyword was “car,” and the filter reason was “low landing page relevance.” In row 414 and row 416, the Impression Position 412 for both auctions is “NULL” because the advertisements submitted by advertiser ID 200 were filtered out of the advertiser auction.

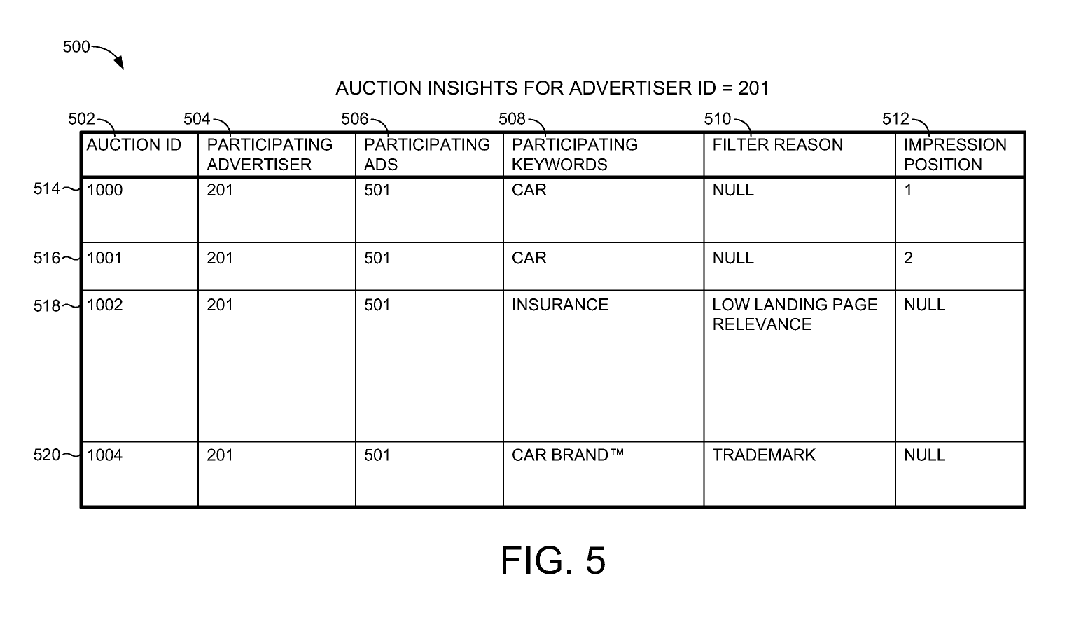

Referring now to FIG. 5, an exemplary report 500 is shown which may be presented to provide insight to Advertiser ID 201. Report 500 includes columns designating Auction ID 502, Participating Advertiser 504, Participating Advertisements 506, Participating Keywords 508, Filter Reason 510, and Impression Position 512. Auction ID 502 represents the identity of a particular auction used to determine which advertisements should be selected for display in association with a particular keyword search query. Participating Advertiser 504 represents the advertiser that participated in the auction designated in Auction ID 502, and for whom the report is being generated. Participating Advertisements 506 represent the advertisements that were submitted by Participating Advertiser 504. Participating Keywords 508 represent the keywords that were participating in each advertiser auction. Filter Reason 510 represents the reasons why a particular Participating Advertisement 506 was filtered out of a particular advertising auction. For Participating Advertisement 406 that was not filtered out of an advertising auction, the value of the Filter Reason 510 is “NULL.” Impression Position 512 represents the value assigned to the advertisement that won the auction, and therefore resulted in an impression. For Participating Advertisements 506 that did not win the auction, the Impression Position 512 value is “NULL.” Individual instances of advertiser auctions are displayed in rows 514-520. For example, row 514 represents the results for auction 1000 for advertiser 201 that submitted participating advertisement 501 in an auction for participating keyword “car.” The Filter Reason 510 value for this instance is “NULL” because advertisement 201 made an impression in Auction ID 1000, as shown by an Impression Position 512 of “1.” The report also summarizes, at row 520, the results of Auction ID 1004 for advertiser 201 that submitted participating advertisement 501 in an auction for participating keyword “CAR BRAND.” Filter Reason 510 shows that the reason for filtration was a trademark conflict. Because advertisement 501 was filtered out of Auction ID 1004, the Impression Position 512 for this auction is “NULL.”

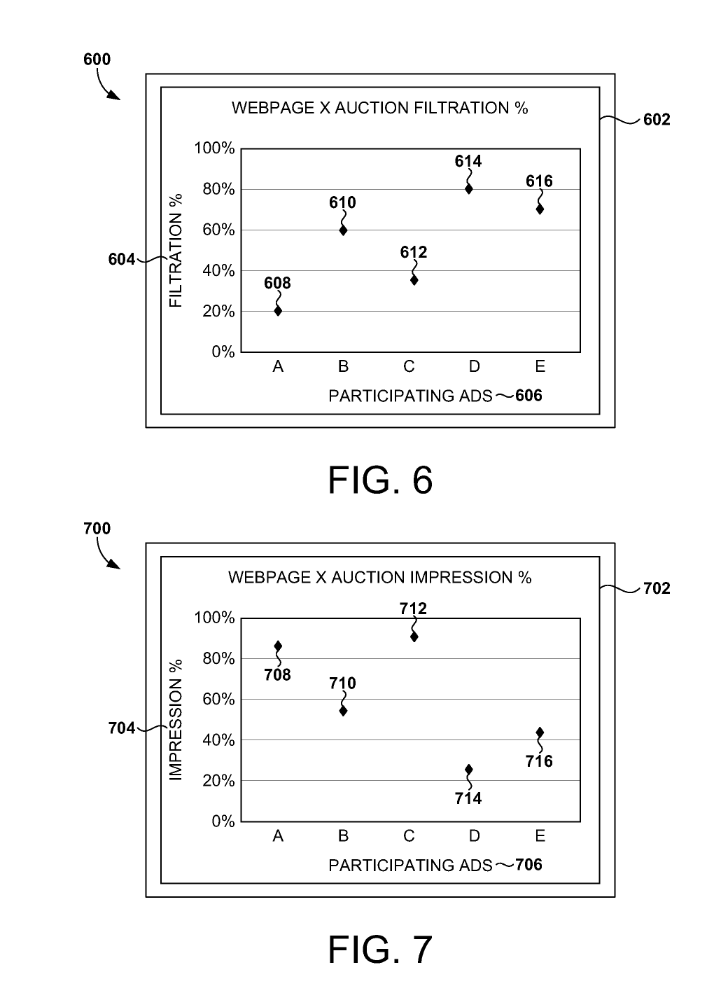

A report may be provided which offers statistical insight to advertisers regarding the outcome of advertiser auctions. FIGS. 6-7 include exemplary reports for use in implementing embodiments of the present invention. It will be understood and appreciated by those of ordinary skill in the art that the reports of FIGS. 6-7 are provided by way of example only and are not intended to limit the scope of the present invention in any way. Further, it should be understood that any combination of FIGS. 3-5 and 6-7 may be provided in a single or multiple reports displayed to a user. As such, a report may be presented to a user that summarizes one or more of the statistics or feedback relevant to the outcome of one or more auctions.

With reference initially to FIG. 6, an exemplary report for implementing embodiments of the present invention is shown. Report 600 displays statistics relevant to the Auction Filtration Ratio of Webpage X in Chart 602. Chart 602 includes a y-axis displaying filtration rates 604, and an x-axis displaying the participating advertisements 606 that were bidding in the auction for display on Webpage X. Data points 608-616 represent the varying filtration rates for the participating advertisements 606. For example, data point 608 represents the filtration rate 604 of approximately 20% for participating advertisement “A.” As previously discussed, a low filtration rate may also represent a high percentage of auction impressions for advertisement “A.”

Referring next to FIG. 7, an exemplary report for implementing embodiments of the present invention is shown. Report 700 displays statistics relevant to the Auction Impression Ratio of Webpage X in chart 702. Chart 702 includes a y-axis displaying impression rates 704, and an x-axis displaying the participating advertisements 706 that were bidding in the auction for display on Webpage X. Data points 708-716 represent the varying filtration rates for the participating advertisements 706. For example, data point 708 represents the filtration rate of approximately 87% for participating advertisement “A.” As previously discussed, a high auction impression rate may also represent a low percentage of auction filtration for advertisement “A.”

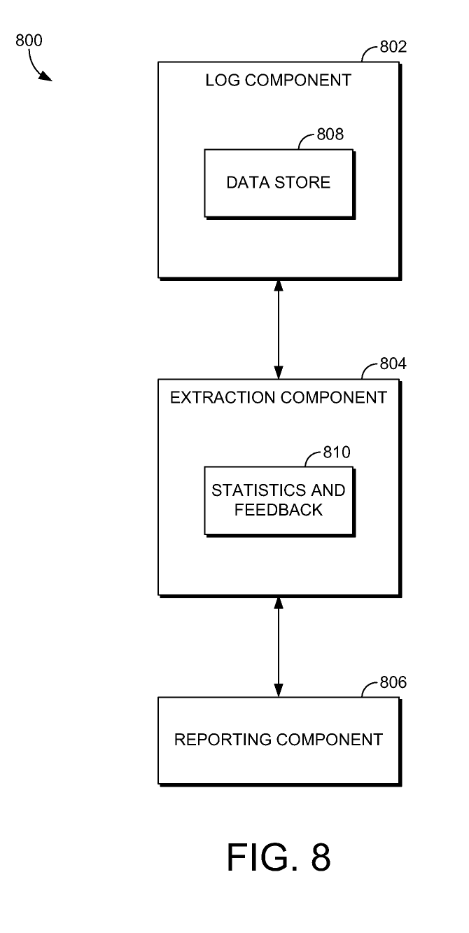

Finally, referring now to FIG. 8, an exemplary computing system 800 generally includes a log component 802, an extraction component 804, and a reporting component 806. The log component 802, extraction component 804, and reporting component 806 may each be executed by a separate computing device, such as computing device 100 described with reference to FIG. 1, for example. Alternatively, the components may be separate applications executed by one or two computing devices. The components of system 800 may communicate with each other via a network, which may include, without limitation, one or more local area networks (LANs) and/or wide area networks (WANs). Such networking environments are commonplace in offices, enterprise-wide computer networks, intranets, and the Internet. It should be understood that any number of log components, extraction components, and reporting components may be employed in the system 800 within the scope of the present invention. Each may comprise a single device or multiple devices cooperating in a distributed environment. For instance, the extraction component 804 may comprise multiple devices arranged in a distributed environment that collectively provide the functionality of the extraction component 804 described herein. Additionally, other components not shown may also be included within the system 800. It will be understood and appreciated by those of ordinary skill in the art that the computing system 800 shown in FIG. 8 is merely an example of one suitable computing system and is not intended to suggest any limitation as to the scope of use or functionality of the present invention. Neither should the computing system 800 be interpreted as having any dependency or requirement related to any single module/component or combination of modules/components illustrated therein

Generally, the system 800 illustrates an environment in which the log component 802 gathers data from advertiser auctions in data store 808. The log component 802 may be any number of components, including an individual device or an application within a computer processor. By way of example only, and not limitation, the log component 802 may be the provider of an online advertiser auction. The data store 808 may be a database of information that is updated with data from advertiser auctions. As previously discussed, the data stored in log component 802 may be configurable, and may be updated periodically or continuously. Log component 802 may be configured to store information associated with advertiser auctions. In various embodiments, such information may include, without limitation, the identity of an advertiser auction, the number and identity of the advertisers that participated in an advertiser auction, the advertisements that were submitted by the advertisers participating in an auction, the keywords that the advertisers were betting on in an auction, how an advertisement was filtered out of the auction, and the outcome of an auction itself. The content and volume of such information are not intended to limit the scope of embodiments of the present invention in any way. Further, though illustrated as a single, independent component, the log component 802 may, in fact, be a plurality of log components, for instance a database cluster.

Extraction component 804 retrieves a sample of data from log component 802. In embodiments, a request for data from extraction component 804 may be received by log component 802. Log component 802 may provide a sample of data from data store 808 to extraction component 804. Extraction component 804 generates statistics and feedback 810 that are derived from the sample of data obtained from log component 802. As such, the statistics and feedback 810 generated by extraction component 804 represent a sample of the advertiser auction data stored in log component 802. As previously discussed, the statistics and feedback generated by extraction component 804 may include an auction filtration ratio, an auction impression ratio, advertisement-level feedback, and keyword level feedback. As the data in data store 808 is updated, extraction component 804 may request additional samples from log component 802, and may generate additional statistics and feedback 810 based on updated samples. Reporting component 806 generates a report based on the statistics and feedback 810 generated from the data retrieved from log component 802.

As can be understood, embodiments of the present invention provide insight to advertisers regarding the outcome of advertiser auctions. The present invention has been described in relation to particular embodiments, which are intended in all aspects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer-readable media storing computer-useable instructions that, when used by one or more computing devices, causes the one or more computing devices to perform a method, the method comprising:
receiving data from one or more advertiser auctions, wherein one or more advertisers participated in the one or more advertiser auctions;
storing the data from the one or more advertiser auctions in a log;
querying the log for a sample of data from the one or more advertiser auctions;
extracting data from the sample regarding one or more advertisements submitted by a single advertiser that participated in the one or more advertiser auctions;
based on the data extracted from the sample, generating at least one of statistics and feedback for the one or more advertisements that participated in the one or more advertiser auctions; and
displaying one or more of statistics and feedback to a user.

2. The one or more computer-readable media of claim 1, wherein generating statistics comprises generating one or more of an auction filtration ratio and an auction impression ratio.

3. The one or more computer-readable media of claim 1, wherein generating feedback includes generating one or more of advertisement-level feedback and keyword-level feedback.

4. The one or more computer-readable media of claim 3, wherein advertisement-level feedback comprises one or more of advertisement copy quality, landing page relevance, and bidding price information.

5. The one or more computer-readable media of claim 3, wherein keyword-level feedback comprises one or more of trademark conflicts and keyword relevance.

6. The one or more computer-readable media of claim 1, wherein the method further comprises:
generating one or more reports regarding the one or more advertisements that were submitted to the one or more advertiser auctions, further wherein the one or more reports summarize one or more of statistics and feedback.

7. The one or more computer-readable media of claim 6, wherein the one or more reports include information regarding one or more of an auction filtration ratio, an auction impression ratio, advertisement copy quality, landing page relevance, bidding price information, trademark conflict, and keyword relevance.

8. The one or more computer-readable media of claim 6, wherein the method further comprises:
communicating the one or more reports to a single advertiser that participated in the one or more advertiser auctions.

9. The one or more computer-readable media of claim 8, wherein the one or more reports are automatically communicated to the single advertiser.

10. The one or more computer-readable media of claim 1, wherein querying the log for a sample of data occurs at regular intervals.

11. The one or more computer-readable media of claim 10, wherein the regular intervals include one or more configurable parameters for a number of days between sampling.

12. A computer system executed by one or more computer processors, comprising:
a log component for storing data from one or more advertiser auctions, wherein one or more advertisers participated in the one or more advertiser auctions;
an extraction component for receiving, from the log component, a sample of data from one or more advertiser auctions, extracting data from the sample regarding one or more advertisements submitted by the one or more advertisers that participated in the one or more advertiser auctions, and generating one or more of statistics and feedback regarding the extracted data; and
a reporting component for generating a report regarding the one or more advertisers that participated in the one or more advertiser auctions.

13. The system of claim 12, wherein the extraction component generates statistics regarding one or more of auction filtration ratio and auction impression ratio.

14. The system of claim 12, wherein the extraction component generates feedback regarding one or more of advertisement-level feedback and keyword-level feedback.

15. The system of claim 14, wherein advertisement-level feedback includes one or more of advertisement copy quality, landing page relevance, and bidding price information.

16. The system of claim 14, wherein keyword-level feedback includes one or more of trademark conflicts and keyword relevance.

17. The system of claim 12, wherein the reporting component automatically communicates the report to the one or more advertisers that participated in the one or more advertiser auctions, further wherein the report includes information regarding one or more of an auction filtration ratio, an auction impression ratio, advertisement copy quality, landing page relevance, bidding price information, trademark conflict, and keyword relevance.

18. One or more computer-readable media storing computer-useable instructions that, when used by one or more computing devices, causes the one or more computing devices to perform a method, the method comprising:
receiving data from one or more advertiser auctions, wherein the one or more advertisers participated in the one or more advertiser auctions;
storing the data from the one or more advertiser auctions in a log;
querying the log for a sample of data from the one or more advertiser auctions;
extracting data from the sample regarding one or more advertisements submitted by the one or more advertisers that participated in the one or more advertiser auctions;
based on the data extracted from the sample, gathering information regarding the one or more advertisements that were submitted by the one or more advertisers that participated in the one or more advertiser auctions;
generating one or more reports regarding the one or more advertisements that were submitted by the one or more advertisers that participated in the one or more advertiser auctions, further wherein the one or more reports include information regarding one or more of an auction filtration ratio, an auction impression ratio, advertisement copy quality, landing page relevance, bidding price information, trademark conflict, and keyword relevance; and
communicating the one or more reports to the one or more advertisers that participated in the one or more advertiser auctions.

19. The one or more computer-readable media of claim 18, wherein the one or more reports are automatically communicated to the one or more advertisers.

20. The one or more computer-readable media of claim 18, wherein querying the log for a sample of data occurs at regular intervals that include one or more configurable parameters for a number of days between sampling.
